(19) United States
(12) Patent Application Publication
(10) Pub. No.: US 2023/0331991 A1
(43) Pub. Date: Oct. 19, 2023

(54) METHOD FOR SOLVOLYSING TYRES WITH RECYCLING OF A HYDROCARBON FRACTION COMPRISING AROMATIC COMPOUNDS

(71) Applicant: IFP Energies nouvelles, Rueil-Malmaison Cedex (FR)

(72) Inventors: Ann CLOUPET, Rueil-Malmaison Cedex (FR); Romina DIGNE, Rueil-Malmaison Cedex (FR)

(73) Assignee: IFP Energies nouvelles, Rueil-Malmaison Cedex (FR)

(21) Appl. No.: 18/028,822

(22) PCT Filed: Sep. 17, 2021
(86) PCT No.: PCT/EP2021/075670

§ 371 Date: Mar. 28, 2023

(30) Foreign Application Priority Data
Sep. 29, 2020 (FR) 2009912

(51) Int. Cl. C09C 1/56; C09C 1/48; B01D 3/14; C10B 53/07

(52) U.S. Cl. CPC C09C 1/482; B01D 3/143; C09C 1/56; C10B 53/07

(57) ABSTRACT

The invention relates to a process for converting used tyres to obtain carbon black, comprising the following steps:
a) sending a solid feedstock based on used tires to a reaction zone in the presence of a liquid solvent to obtain a vapor effluent and a first liquid effluent comprising the carbon black,
b) sending the liquid effluent to a filtration and washing unit to obtain a filtered and washed carbon black cake and a second liquid effluent;
c) sending said vapor effluent and the second liquid effluent to a fractionation zone to obtain at least one hydrocarbon cut;
d) sending said hydrocarbon cut obtained at the end of step c) to the reaction zone as liquid solvent of step a);
e) drying the carbon black cake.

### FIELD OF THE INVENTION

The present invention relates to a process for converting used tires by thermal decomposition.

### PRIOR ART

Processes for converting used tires by thermal decomposition are generally directed toward producing gaseous, liquid and solid fractions. The tire is generally initially ground to obtain either ground tire material still containing a portion of the textile fibers or metal wires contained in the tire (typically pieces of 1 to 10 cm) or granules (generally less than 6 mm in size) free of textile fibers or metal wires. It is possible to react these feedstocks thus prepared by exposing them to heat to decompose the used tire and to recover a gaseous fraction, a liquid fraction and a solid fraction. To succeed in decomposing the tire, it is generally necessary to expose the tire to a quite high temperature, generally between 300° C. and 900° C. for reaction times ranging from 30 minutes to several hours.

Numerous technologies exist for performing these reactions. For example, the tires may be subjected to high temperatures in rotating furnaces (Lewandowski et al., Journal of Analytical and Applied Pyrolysis, 140, 2019, 25-53), or in moving beds (EP2661475). These technologies are robust, but generally require working at quite high temperatures, generally on average above 500° C. In these processes, the carbon black generally present in the feedstock in a proportion of 25-40% by weight and originally consisting of very fine sub-micrometric or micrometric particles/agglomerates, tends to agglomerate in the presence of the decomposed rubber which forms a coke binding these structures at various scales, the solid often leaving the reactor in the form of blocks of several millimeters/centimeters which then need to be finely ground in order to reuse this solid as carbon black, which requires substantial energy expenditure. In these processes, the temperature conditions are high and essentially gaseous and solid fractions are found in the reactor. The liquids produced then result from condensation of the gaseous products downstream of the reactor. These high temperature conditions moreover tend to promote polycondensation and coking reactions to form polyaromatic structures via cyclization reactions involving the aromatic and olefinic structures present (M.F. Laresgoiti, B.M. Caballero, I. de Marco, A. Torres, M.A. Cabrero, M.J. Chomón. J. Anal. Appl. Pyrolysis 71 (2004) 917-934) or coke. The higher the temperature, the greater the contents of polyaromatic structures formed and of coke formed. Now, while aromatic molecules are, firstly, good solvents and, secondly, find numerous applications, notably as petrochemical bases, polyaromatic structures are, on the other hand, prejudicial to the quality of the liquid formed and very difficult to refine or to convert. Furthermore, they are coke precursors. There is thus every interest in seeking to minimize polycondensation reactions in order to produce a minimum of polyaromatic structures while preserving the monoaromatic structures present.

To improve the quality of the solid phase and to limit the formation of coke on carbon black, it is possible to lower the partial pressure of hydrocarbons by injecting steam during the cracking reactions which nevertheless require a high temperature above 500° C. to perform the cracking under essentially gas-solid conditions (US 2016/0083657). These gas-solid processes generally lead to productions of noncondensable gases under the atmospheric conditions, these productions being very high and between 10% and 25% by weight relative to the tire feedstock entering the reactor. However, upgrading of reaction gases is locally complex. These gases are thus generally used to produce the heat required to perform the reactions, but this is done at the expense of the amount of readily upgradable liquid products, which is then limited. These liquid fractions are, specifically, subsequently optionally upgraded to produce new hydrocarbon cuts (naphtha, gasoline, kerosene, gas oil, vacuum distillate, residues) used in a refinery to produce fuels or in petrochemistry to produce bases subsequently used for the production of plastics. It is nevertheless necessary to refine these cuts in order to bring them to the desired specifications. The more numerous the polyaromatic structures, the more complex the refining.

An alternative route consists in placing the tire feedstocks in contact with a liquid, raising the temperature of this liquid and dissolving and converting the tires into a homogeneous liquid phase in which the tire feedstock is stirred and gradually disappears. An example of this implementation is given in US 3 978 199 and US 3 704 108. This type of process makes it possible to recover carbon black in the liquid phase after filtration without these particles having undergone agglomeration or deposition of coke at their surface, as is the case in the reactions operating in the gas-solid phase. Implementation under temperature conditions below 450° C. moreover limits the polycondensation reactions of the aromatics, the formation of coke at the surface of the carbon black particles and the formation of gases, which is generally between 1% and 7% by weight of the entering feedstock. The use of a solvent containing aromatic fractions, preferentially monoaromatic fractions, is favorable and enables better dissolution of the feedstock in the reactor. As tires are, naturally, composed of various rubbers including large amounts of synthetic rubber composed of styrene-butadiene rubbers (SBR), the liquid fractions produced contain large amounts of aromatics and it may be advantageous to separate and recycle a portion of the liquid formed during the reaction to use it as solvent, while the liquid fraction that is not recycled may be sent to a refinery to be refined and then upgraded as a hydrocarbon cut to feed the product pools or petrochemistry. By way of example, in document US 3,978,199, the heavy fraction of the filtrate obtained after distillation, comprising aromatic compounds, is heated and then recycled to the reactor as liquid solvent. However, depending on the composition of the heavy fraction used to dissolve the solid feedstock, and also the recycle ratio of the heavy fraction relative to the solid feedstock, the filtration time of the carbon black can vary considerably. The applicant has developed a new process for converting used tires that makes it possible to prevent the abovementioned drawbacks by optimizing the existing process as described in document US 3,978,199.

### SUBJECTS OF THE INVENTION

One subject of the present invention is a process for converting used tyres to obtain carbon black, comprising at least the following steps:
a) sending a solid feedstock based on used tires to a reaction zone in the presence of a liquid solvent comprising aromatic compounds to at least partly dissolve said solid feedstock and to thermally decompose said at least partially dissolved solid feedstock at a temperature below or equal to 425° C. and at a pressure of less than 1.5 MPa in order to obtain a gaseous effluent and a first liquid effluent comprising carbon black, the weight ratio between the liquid solvent and the solid feedstock being greater than 3 weight/weight;
b) sending the first liquid effluent obtained in step a) to a filtration and washing zone in the presence of a washing solvent in order to obtain a filtered and washed carbon black cake and a second liquid effluent;
c) sending, at least in part, said gaseous effluent obtained at the end of step a) and, at least in part, the second liquid effluent obtained at the end of step b) to a fractionation zone to obtain at least one hydrocarbon cut having a content of aromatic compounds of greater than 30% by weight relative to the total weight of said hydrocarbon cut, and further having:
   a content of C5-C10 hydrocarbon compounds of less than 20% by weight relative to the total weight of the hydrocarbon cut; and
   a content of C40+ hydrocarbon compounds of less than 5% by weight relative to the total weight of said hydrocarbon cut;
d) sending, at least in part, said hydrocarbon cut obtained at the end of step c) to the reaction zone as liquid solvent of step a);
e) drying the filtered and washed carbon black cake obtained at the end of step b) at a temperature of between 50° C. and 200° C. to recover the carbon black.

The applicant has surprisingly discovered that the use of such a recycled hydrocarbon cut as a liquid solvent in the used tire conversion zone, comprising a content rich in aromatic compounds, low in C40+ compounds (vacuum residues), and a content of C5-C10 hydrocarbon compounds (gasoline) that is not too high, with a specific solvent/solid feedstock weight ratio, synergistically allows better dissolution and decomposition of the solid feedstock thus maximizing the production of carbon black.

In one embodiment according to the invention, before step a) of said process, said solid feedstock is sent to a pretreatment unit to at least partly remove the textile fibers and metal wires contained in said solid feedstock.

In one embodiment according to the invention, step a) comprises the following substeps:
a1) sending said solid feedstock and said liquid solvent to a first stirred reactor to at least partly dissolve said solid feedstock;
a2) sending said at least partly dissolved solid feedstock obtained at the end of step a1) to a second stirred reactor to thermally decompose said solid feedstock at a temperature below or equal to 425° C. and to obtain the first liquid effluent containing carbon black particles in suspension.

In one embodiment according to the invention, the content of aromatic compounds in the hydrocarbon cut is greater than 40% by weight relative to the total weight of said cut.

In one embodiment according to the invention, the content of C5-C10 hydrocarbon compounds in the hydrocarbon cut is less than 10% by weight relative to the total weight of said cut.

In one embodiment according to the invention, the content of C40+ hydrocarbon compounds in the hydrocarbon cut is less than 3% by weight relative to the total weight of said cut.

In one embodiment according to the invention, the weight ratio between said liquid solvent and the solid feedstock is greater than 3 weight/weight.

In one embodiment according to the invention, the viscosity of the second liquid effluent at 100° C. is less than 10 cP as measured according to the standard ASTM D3236.

In one embodiment according to the invention, in step c) of said process, a light cut is also obtained, the final boiling point of which is preferentially between 250° C. and 325° C.

In one embodiment according to the invention, the light cut is sent at least in part upstream to a distillation column to obtain at least one light cut, the final boiling point of which is below or equal to 200° C.

In one embodiment according to the invention, said light cut, the final boiling point of which is below or equal to 200° C., is sent at least in part to the filtration/washing zone as washing solvent according to step b) of said process.

In one embodiment according to the invention, step b) comprises the following substeps:
b1) filtering the liquid effluent in a washing and filtration device to obtain a filtered carbon black cake and a liquid fraction;
b2) washing the filtered carbon black cake obtained at the end of step b1) in the presence of a washing solvent to obtain the filtered and washed carbon black cake and a washing stream.

Preferably, the washing stream is sent to an intermediate fractionation unit to obtain a cut which is recycled at least in part upstream of the washing and filtration device as washing solvent.

Advantageously, the hydrocarbon cut has a content of C10-C20 hydrocarbon compounds of between 20% and 65% by weight relative to the total weight of the hydrocarbon cut. Advantageously, the hydrocarbon cut has a content of C20-C40 hydrocarbon compounds of between 30% and 80% by weight relative to the total weight of the hydrocarbon cut.

Advantageously, the hydrocarbon cut has an initial boiling point of between 50° C. and 325° C. and a final boiling point of between 350° C. and 520° C.

### LIST OF FIGURES

FIG. 1 is a diagrammatic representation of the process according to the invention.

FIG. 2 is a diagrammatic representation of the process shown in FIG. 1 in which the reaction zone and the filtration and washing zone of the process are shown in more detail.

### DETAILED DESCRIPTION

Cn hydrocarbon cut is understood to mean a cut comprising hydrocarbons having n carbon atoms.

Cn+ cut is understood to mean a cut comprising hydrocarbons having at least n carbon atoms.

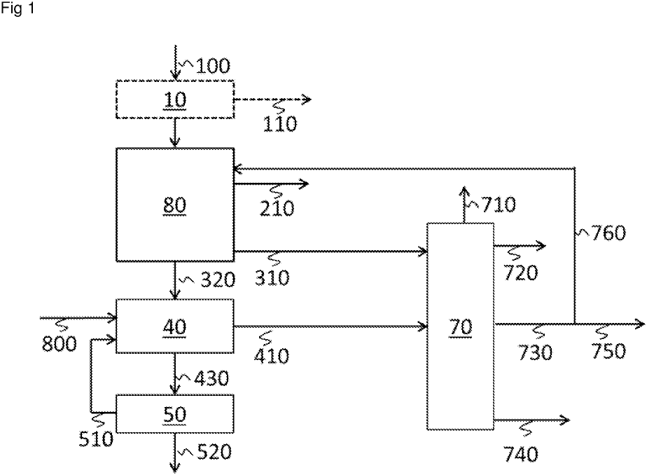

With reference to FIG. 1, representing an embodiment according to the invention, the process for converting used tires comprises at least the following steps:
a) sending a solid feedstock 100 based on used tires to a reaction zone 80 in the presence of a liquid solvent 760 comprising aromatic compounds to at least partly dissolve said solid feedstock and to thermally decompose said at least partially dissolved solid feedstock at a temperature below or equal to 425° C., preferably between 375° C. and 425° C., and at a pressure of less than 1.5 MPa, preferably between 0.5 and 1.2 MPa, in order to obtain a gaseous effluent 310 and a first liquid effluent 320 comprising carbon black, the weight ratio between the liquid solvent 760 and the solid feedstock 100 being greater than 3 weight/weight;
b) sending the liquid effluent 320 obtained in step a) to a filtration and washing zone 40 in the presence of a washing solvent in order to obtain a filtered and washed carbon black cake 430 and a second liquid effluent 410;
c) sending, at least in part, preferably entirely, said gaseous effluent 310 obtained at the end of step a) and, at least in part, preferably entirely, the second liquid effluent 410 obtained at the end of step b) to a fractionation zone 70 to obtain at least one hydrocarbon cut 730 having a content of aromatic compounds of greater than 30% by weight relative to the total weight of said hydrocarbon cut, preferably greater than 40% by weight, and having:
   a content of C5-C10 hydrocarbon compounds of less than 20% by weight relative to the total weight of the hydrocarbon cut 730, preferably less than 10% by weight, more preferentially between 1% and 8% by weight; and
   a content of C40+ hydrocarbon compounds of less than 5% by weight relative to the total weight of said hydrocarbon cut 730, preferably less than 3% by weight, more preferentially less than 1% by weight, and even more preferentially less than 0.5% by weight;
d) sending, at least in part, said hydrocarbon cut 730 obtained at the end of step c) to the reaction zone 80 as liquid solvent 760 of step a);
e) drying the filtered and washed carbon black cake 430 obtained at the end of step b) at a temperature of between 50° C. and 200° C., preferably for a time sufficient for the content of washing solvent in the dried cake to be less than 0.5% by weight relative to the total weight of said dried cake. Advantageously, the drying time is between 10 minutes and 36 hours, more preferentially between 1 hour and 15 hours, to recover the carbon black 520.

The solid feedstock 100 used in the context of the present invention is advantageously based on tires resulting from the processing of used tires which may originate from any source, for instance light vehicles (LV) or heavy goods vehicles (HGV). Said solid feedstock may advantageously be in the form of tyre granules, i.e. in the form of particles less than 6 mm in size. Preferably, said solid feedstock 100 is substantially free of textile fibers and metal wires, and/or of ground tyre materials, i.e. pieces of ground tyres, with a characteristic size generally between 1 cm and 20 cm. Thus, according to a preferred embodiment according to the invention, the solid feedstock 100 is sent to a pretreatment unit 10 in order to remove textile fibers and metal wires 110 from the solid feedstock 100. Such a pretreatment unit is well known to those skilled in the art and can consist of grinders of various types (i.e. a rotary shear, a shredder, a granulator, a rechipper), a magnetic separator, or else a vibrating screen, a separation table.

According to step a) of the conversion process, the rubber which is contained in the solid feedstock 100 is dissolved in contact with the liquid solvent 760 and then is thermally decomposed. The origin and composition of the liquid solvent 760 will be described in detail below. Step a) is preferably carried out at a temperature below or equal to 425° C., preferably at a temperature of between 375° C. and 425° C., and at a pressure of less than 1.5 Mpa, preferably between 0.8 MPa and 1.2 MPa. At the end of step a), the at least one gaseous effluent 310 is obtained and the first liquid effluent 320 comprising carbon black, and optionally solids 210 contained in the used tires, such as metal wires or textile fibers, which are released and separated from the liquid effluent 320 obtained at the end of this step.

The first liquid effluent 320 comprising the carbon black is then sent to the filtration and washing zone 40 (i.e. step b) of the preparation process according to the invention) in order to recover the filtered and washed carbon black cake 430 and the second liquid effluent 410. In one embodiment according to the invention, the viscosity of the second liquid effluent 410 measured at 100° C. is less than 10 cP, preferentially less than 5 cP, more preferentially less than 3 cP, as measured according to the standard ASTM D3236.

The filtration and washing unit can comprise any device allowing the filtration of the carbon black particles contained in the first liquid effluent 320. Such a device may for example be in the form of a rotary filter operating preferentially at a temperature between 50° C. and 200° C. During step b), the carbon black cake is washed using a washing solvent.

In one embodiment according to the invention, the washing solvent used during step b) is a solvent external to the process 800, as shown in FIG. 1. Such a solvent may for example be toluene.

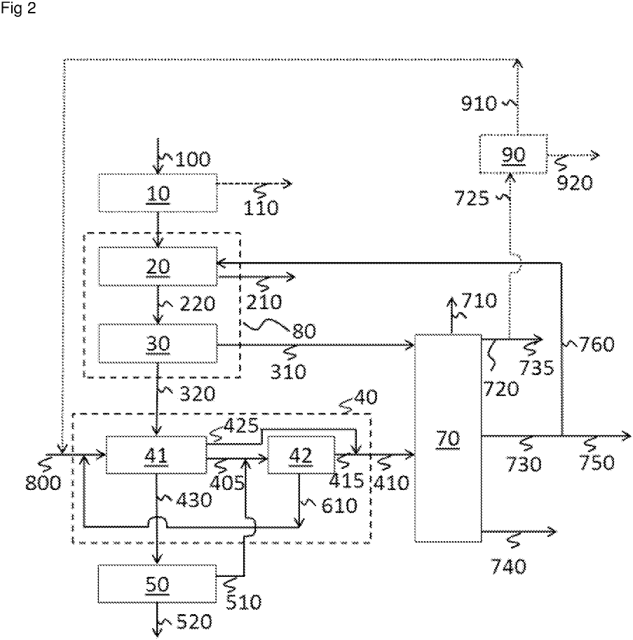

In another embodiment according to the invention, the washing solvent used during step b) is composed, at least partly, of a light cut 720 obtained at the end of step c). More particularly, with reference to FIG. 2, a fraction of the light cut 720 can be sent to a distillation column 90 through the line 725. The supplementary fraction 735 of the light cut is sent out of the process according to the invention as an upgradable product. At the outlet of the distillation column 90, a light cut 910 comprising aromatic compounds is obtained, the final boiling point of which is below or equal to 200° C., preferably below 150° C., which can be used at least in part as washing solvent for the filtration/washing zone 40. The heavier cut 920 can be sent out of the process as an upgradable product 920.

The filtered and washed carbon black cake 430 is sent to a drying unit 50 operating at a temperature of between 50° C. and 200° C., preferably between 50° C. and 150° C. in order to recover the carbon black 520 (i.e. step e) of the process according to the invention). Advantageously, the vapor effluent 510 from the drying unit 50 comprising the washing solvent is recycled to the washing/filtration unit 40.

According to an essential feature of the conversion process according to the invention, the gaseous effluent 310 obtained at the end of step a) and the second liquid effluent 410 obtained at the end of step b) are sent to the fractionation unit 70 (i.e. step c) of the process according to the invention) to produce at least one hydrocarbon cut 730 comprising a content of aromatic compounds of greater than 30% by weight relative to the total weight of said hydrocarbon fraction 730, and further comprising at least:
a content of C5-C10 hydrocarbon compounds of less than 20% by weight relative to the total weight of the hydrocarbon cut 730, preferably less than 10% by weight, more preferentially between 1% and 8% by weight; and
a content of C40+ hydrocarbon compounds of less than 5% by weight relative to the total weight of said hydrocarbon cut 730, preferably less than 3% by weight, more preferentially less than 1% by weight, and even more preferentially less than 0.5% by weight.

Advantageously, the hydrocarbon cut 730 also has a content of C10-C20 hydrocarbon compounds of between 20% and 65% by weight relative to the total weight of the hydrocarbon cut, preferably between 30% and 65% by weight, and even more preferentially between 45% and 65% by weight.

Advantageously, the hydrocarbon cut 730 also has a content of C20-C40 hydrocarbon compounds of between 30% and 80% by weight relative to the total weight of the hydrocarbon cut, preferably between 30% and 70% by weight, and even more preferentially between 30% and 55% by weight.

Advantageously, the hydrocarbon cut 730 has an initial boiling point of between 50° C. and 325° C., preferably between 50° C. and 250° C., and a final boiling point of between 350° C. and 520° C., preferably between 350° C. and 450° C.

Specifically, the applicant has observed that the use of such a recycled hydrocarbon cut as a liquid solvent 760 of the reaction zone 80 (i.e. step d) of the process according to the invention), with a content rich in aromatic compounds, low in C40+ compounds (vacuum residues), and a content of C5-C10 hydrocarbon compounds (gasoline) that is not too high, and using a solvent/solid feedstock weight ratio of greater than 3 weight/weight, preferably between 3 and 10 weight/weight, more preferentially between 4 and 7 weight/weight, synergistically allows better dissolution and decomposition of the solid feedstock 100 thus maximizing the production of carbon black. This results notably in a shorter filtration time of the carbon black in the washing/filtration zone 40.

Advantageously, the fractionation zone 70 also makes it possible to obtain noncondensable gases 710, light cut 720, the final boiling point of which is preferentially between 250° C. and 325° C., and a heavy cut 740, the initial boiling point of which is preferentially between 350° C. and 450° C. Advantageously, the light cut 720 can be sent, at least in part, as washing solvent to the washing and filtration zone 40 to obtain the filtered and washed carbon black cake 430. Advantageously, the light cut 720 has a content of C10- hydrocarbon compounds of greater than 60% by weight relative to the total weight of the light cut 720.

Advantageously, the heavy cut 740 has a content of C40+ hydrocarbon compounds of greater than 60% by weight relative to the total weight of the heavy cut 740.

According to the invention, a fraction of the hydrocarbon cut 730 is sent, at least in part, to the reaction zone 80 of step a) as liquid solvent 760, the other part 750 being advantageously sent out of the process according to the invention as an upgradable product. The weight ratio between the liquid solvent 760 and the flow of the solid feedstock 100 injected into the reaction zone 80 is greater than 3 weight/weight (w/w), preferably between 3 and 10 weight/weight, more preferentially between 4 and 7 weight/weight. Specifically, one of the features of the liquid solvent 760 is that it contains a content of aromatics of greater than 30% by weight relative to the total weight of said liquid solvent 760, making it possible to effectively dissolve the solid feedstock 100 and to effectively reduce the viscosity of the reaction medium in the reaction zone 80. Another advantage of the process according to the invention is that the use of such a solvent makes it possible to remain in liquid form while limiting the pressure in the reactors to a level below 1.5 MPa given the limited production of gas and light hydrocarbons in the reaction zone 80 and the low content of C10- hydrocarbon compounds in the hydrocarbon cut 730.

In order to better understand the invention, the description given below as an application example relates to a process for converting used tyres which makes it possible to maximize the the recovery of carbon black. With reference to FIG. 2, the solid feedstock 100 is sent to a pretreatment unit 10 in order to remove textile fibers and metal wires 110 from the solid feedstock 100. The solid feedstock substantially free of textile fibers and metal wires is then sent to the reaction zone 80 enabling the thermal degradation of the used tires and comprising a first stirred reactor 20 fed with liquid solvent 760 and that aims to promote the dissolution of the tire granules or ground material contained in the solid feedstock 100. The liquid solvent/solid feedstock weight ratio is greater than 3 weight/weight, preferably between 3 and 10, more preferentially between 4 and 7 weight/weight. The temperature in the reactor 20 is preferentially between 200° C. and 300° C., preferentially between 250° C. and 290° C. In the first stirred reactor 20, the ground material or granules are dissolved. The time required to perform this dissolution is preferentially between 30 minutes and 2 hours. The rubber pieces, and the carbon black which gradually becomes released from the rubber, remain in suspension by means of mechanical stirring or hydrodynamic stirring, induced for example by a liquid upflow resulting from a recirculation by forced convection, or by any other means for keeping the medium stirred. The metal wires which may still be present in the solid feedstock and which have not been dissolved, settle and leave the first stirred reactor 20 at the bottom thereof via the line 210. Under these conditions, the temperature is too low for the carbon-carbon cracking reactions to start significantly and only the crosslinking bonds between polymers, such as the S-S bonds associated with the vulcanization of the rubbers, can crack substantially. The liquid fraction 220 obtained containing the residual solids in suspension is sent to a second stirred reactor 30 in which the thermal degradation reactions are performed under moderate temperature conditions, i.e. at a temperature below or equal to 425° C., preferably between 375° C. and 425° C., and for a limited time (corresponding to the residence time of the liquid fraction in the reactor 30) preferentially between 30 minutes and 2 hours, preferentially between 45 minutes and 90 minutes. The amount of heat required to perform the thermal degradation reactions may be provided by an exchanger located on a pump-around (not shown in the figures) around the second stirred reactor 30, or by any other means such as an exchanger on the wall of the reactor or an exchanger or a furnace on the feedstock upstream of the reactor, for example. Stirring is maintained in the second stirred reactor 30 by means of a mechanical stirring system or by the pump-around system or by any other means known to those skilled in the art. Preferentially, the pressure of the reactor is maintained at a level below 1.5 MPa by means of a control valve (not shown in the figures).

At the end of the reaction in the second stirred reactor 30, the first liquid effluent 320 containing the carbon black particles in suspension and the gaseous effluent 310 are obtained. The first liquid effluent 320 is then sent to the filtration and washing zone 40, comprising a rotary filter 41 and an intermediate fractionation unit 42 (cf. FIG. 2). The rotary filter 41 preferentially operates at a temperature between 50° C. and 200° C., and makes it possible to obtain a carbon black cake and a liquid fraction 425. The carbon black cake is then washed by the washing solvent 800 such as toluene, at a temperature preferentially between 50° C. and 100° C., making it possible to recover the filtered and washed carbon black 430. After the filtration/washing step, a washing stream 405 can be sent to the intermediate fractionation unit 42 to obtain a cut 610 which can be recycled at least in part upstream of the rotary filter 41 by means of the line as additional washing solvent, and a cut 415 which can be sent with the liquid fraction 425, to the fractionation zone 70 as second liquid effluent 410. The filtered and washed carbon black 430 is then sent to the drying unit 50 operating at a temperature between 50° C. and 200° C., advantageously for a time sufficient for the content of washing solvent in the dried cake to be less than 0.5% by weight relative to the total weight of said dried cake. The filtered, washed and dried carbon black 520 can then advantageously be pelletized (granulated) with water to form pellets of a few millimeters for example to facilitate the transportation and upgrading thereof. The carbon black thus produced can be used again in the elastomer industry as a reinforcing agent, or as a pigment for other applications, for example in inks, plastics or paints, after steps of subsequent processing and packaging of the material as a function of the uses and applications. The residual washing solvent can be recovered at the outlet of the drying unit 50 and be at least partly recovered via the line 510.

The gaseous effluent 310 leaving the reaction zone 80 via the second reactor 30, and the second liquid effluent 410 from the washing/filtration zone 40 are then sent to the fractionation zone 70. The fractionation zone 70 may consist of heat exchangers, gas-liquid separator drums, a distillation column containing a top take-off, a bottom take-off and a side take-off, or a sequence of several distillation columns, such as a sequence of a distillation column at atmospheric pressure operating with a top take-off and a bottom take-off, followed by a distillation column operating under a low vacuum. This fractionation zone 70 makes it possible in particular to produce the hydrocarbon cut 730 comprising a content of aromatic compounds of greater than 30% by weight relative to the total weight of said hydrocarbon cut 730, preferentially greater than 40% by weight, and further having:
a content of C5-C10 hydrocarbon compounds of less than 20% by weight relative to the total weight of the hydrocarbon cut 730, preferably less than 10% by weight, more preferentially between 1% and 8% by weight; and
a content of C40+ hydrocarbon compounds of less than 5% by weight relative to the total weight of said hydrocarbon cut 730, preferably less than 3% by weight, more preferentially less than 1% by weight, and even more preferentially less than 0.5% by weight;
   at least a portion of which can be recycled as a liquid solvent 760 to the reaction zone 80, it being possible for the other portion 750 to be upgraded as product. Preferably, the hydrocarbon cut is sent to the first reactor 20 of the reaction zone 80 as liquid solvent.

This fractionation zone 70 also makes it possible to obtain noncondensable gases 710, the light cut 720, the final boiling point of which is preferentially between 250° C. and 325° C., and the heavy cut 740, the initial boiling point of which is preferentially between 350° C. and 450° C. Advantageously, the light cut 720 can be sent, at least in part, as washing solvent to the washing and filtration device 41 of the washing and filtration zone 40 to obtain the filtered and washed carbon black cake 430.

During the start-up of the facility, in the absence of production of a stabilized intermediate cut, i.e. the hydrocarbon cut 730, it is possible temporarily to use an imported solvent which will preferentially be constituted of a content of aromatic molecules of greater than 40% by weight relative to the total weight of the cut. This cut may thus be constituted, for example, of conversion effluents from the process of fluid catalytic cracking (FCC) of middle distillate (light cycle oil (LCO)) or of heavy distillate (heavy cycle oil (HCO)), for example.

### EXAMPLES

The examples that follow illustrate preferential embodiments of the process according to the present invention without, however, limiting the scope thereof. The process used for illustrating the invention is in accordance with that described in FIG. 2.

In a first example, in accordance with the invention, use is made of used tire granules (solid feedstock), produced by granulators using grinders, which originate from heavy goods vehicle tires and the grains resulting from the grinding have a size close to 2 millimeters. The tire granules result from a pretreatment unit 10 and are free of textile and metal fibers. The granules are then sent continuously to a dissolution reactor where they are mixed with the liquid solvent resulting from the recycling of the hydrocarbon cut 730 from the fractionation zone 70. A portion of the hydrocarbon cut 730 is used as liquid solvent 760, the composition of which is shown in table 1 below. The amount of solid feedstock treated is 100 kg/h. The amount of solvent that is recycled to the reactor 20 is 500 kg/h, corresponding to a solvent/granule weight ratio equal to 5 w/w. In the reactor 20, the temperature is maintained equal to 290° C., which makes it possible to dissolve the granules. The liquid fractions and the carbon black in suspension are then sent to the reactor 30 where the temperature is maintained equal to 400° C. for one hour. At the outlet of the reactor 30, a first liquid effluent 320 and a gaseous effluent 310 are recovered, the latter being sent entirely to the fractionation zone 70. The first liquid effluent 320 is sent to a rotary filter 41 operating at 140° C. The filtered carbon black is washed with toluene. The second liquid effluent 410 collected at the outlet of the washing and filtration zone 40 is sent in its entirety to the fractionation zone 70. The filtered and washed carbon black 430 is sent to a drying unit 50 operating at 150° C. for 24 hours to recover the filtered, washed and dried carbon black 520.

In examples 2 to 5, not in accordance with the invention, the steps of the conversion process and the operating conditions are identical to those of example 1, except for the following features:
examples 2 and 3: the content of C40+ hydrocarbon compounds (vacuum residues (VR)) in the liquid solvent 760 is outside the range according to the invention;
example 4: the content of C5-C10 hydrocarbon compounds (gasoline) in the hydrocarbon cut 760 is outside the range according to the invention;
example 5: the solvent/solid feedstock weight ratio is outside the range according to the invention.

TABLE 1

| | | Examples | | | | |
|---|---|---|---|---|---|---|
| | | 1 | 2 | 3 | 4 | 5 |
| Temperature of the reactor 30 | °C | 400 | 400 | 400 | 400 | 400 |
| Pressure of the reactor 30 | MPa | 0.9 | 0.9 | 0.9 | 0.9 | 0.9 |
| Flow rate of feedstock 100 | kg/h | 100 | 100 | 100 | 100 | 100 |
| Liquid solvent 760 /feedstock 100 | w/w | 5 | 5 | 5 | 5 | 1.8 |
| Flow rate of recycle stream 760 | kg/h | 500 | 500 | 500 | 500 | 179 |
| Hydrocarbon cut 760 | | | | | | |
| Gas | wt% | 0.2 | 0.2 | 0.1 | 1.1 | 0.1 |
| Gasoline (C5-205° C.) | wt% | 6.6 | 6.2 | 5.3 | 26.2 | 4.5 |
| Gas oil (205-370° C.) | wt% | 59.3 | 52.6 | 40.9 | 56.6 | 62.3 |
| VGO (370-520° C.) | wt% | 33.6 | 33.1 | 33.6 | 15.9 | 32.8 |
| VR (520° C.+) | wt% | 0.4 | 8.0 | 20.0 | 0.2 | 0.3 |
| Gaseous effluent 310 | kg/h | 85 | 73 | 54 | 393 | 47 |
| Liquid effluent 320 | kg/h | 515 | 527 | 546 | 207 | 232 |
| Solids in liquid effluent 320 | wt% | 7.3 | 7.2 | 6.9 | 18.2 | 16.2 |
| Viscosity of the second liquid effluent 410 at 50° C. | cP | 6.2 | 12.0 | 28.8 | 12.0 | 12.0 |
| Viscosity of the second liquid effluent 410 at 100° C. | cP | 2.3 | 3.8 | 7.4 | 3.7 | 3.8 |
| Time to filter the carbon black | | Base | Base x 4 | Base x 8 | Base x 4 | Base x 4 |

By comparing the results in terms of carbon black filtration time relative to example 1 according to the invention, it is found that when the content of C40+ hydrocarbon compounds (vacuum residue) is 8% by weight in the hydrocarbon cut 730 relative to the total weight of said cut (example 2), the carbon black filtration time is 4 times longer, or even 8 times longer when the content of C40+ hydrocarbon compounds is 20% by weight (example 3). Furthermore, when the content of C5-C10 hydrocarbon compounds (gasoline) is 26% by weight in the hydrocarbon cut 730, the carbon black filtration time is 4 times longer (example 4). Finally, a liquid solvent 760 / solid feedstock 100 weight ratio that is not optimized significantly lengthens the carbon black filtration time (example 5).

1. A process for converting used tyres to obtain carbon black, comprising at least the following steps:
a) sending a solid feedstock (100) based on used tires to a reaction zone (80) in the presence of a liquid solvent (760) comprising aromatic compounds to at least partly dissolve said solid feedstock and to thermally decompose said at least partially dissolved solid feedstock at a temperature below or equal to 425° C. and at a pressure of less than 1.5 MPa in order to obtain a gaseous effluent (310) and a first liquid effluent (320) comprising carbon black, the weight ratio between the liquid solvent (760) and the solid feedstock (100) being greater than 3 weight/weight;
b) sending the first liquid effluent (320) obtained in step a) to a filtration and washing zone (40) in the presence of a washing solvent in order to obtain a filtered and washed carbon black cake (430) and a second liquid effluent (410);
c) sending, at least in part, said gaseous effluent (310) obtained at the end of step a) and, at least in part, the second liquid effluent (410) obtained at the end of step b) to a fractionation zone (70) to obtain at least one hydrocarbon cut (730) having a content of aromatic compounds of greater than 30% by weight relative to the total weight of said hydrocarbon cut, and further having:
a content of C5-C10 hydrocarbon compounds of less than 20% by weight relative to the total weight of the hydrocarbon cut; and
a content of C40+ hydrocarbon compounds of less than 5% by weight relative to the total weight of said hydrocarbon cut;
d) sending, at least in part, said hydrocarbon cut (730) obtained at the end of step c) to the reaction zone (80) as liquid solvent (760) of step a);
e) drying the filtered and washed carbon black cake (430) obtained at the end of step b) at a temperature of between 50° C. and 200° C. to recover the carbon black.

2. The process as claimed in claim 1, wherein, before step a), said solid feedstock (100) is sent to a pretreatment unit (10) to at least partly remove the textile fibers and metal wires contained in said solid feedstock (100).

3. The process as claimed in claim 1, wherein sFIGtep
a) comprises the following substeps:
a1) sending said solid feedstock (100) and said liquid solvent (760) to a first stirred reactor (20) to at least partly dissolve said solid feedstock (100);
a2) sending said at least partly dissolved solid feedstock obtained at the end of step a1) to a second stirred reactor (30) to thermally decompose said solid feedstock at a temperature below or equal to 425° C. and to obtain a liquid effluent containing carbon black particles in suspension.

4. The process as claimed in claim 1, wherein the content of aromatic compounds in the hydrocarbon cut (730) is greater than 40% by weight relative to the total weight of said cut.

5. The process as claimed in claim 1, wherein the content of C5-C10 hydrocarbon compounds in the hydrocarbon cut (730) is less than 10% by weight relative to the total weight of said cut.

6. The process as claimed in claim 1, wherein the content of C40+ hydrocarbon compounds in the hydrocarbon cut (730) is less than 3% by weight relative to the total weight of said cut.

7. The process as claimed in claim 1, wherein the viscosity of the second liquid effluent (410) at 100° C. is less than 10 cP as measured according to the standard ASTM D3236.

8. The process as claimed in claim 1, wherein, in step c), a light cut (720) is also obtained, the final boiling point of which is preferentially between 250° C. and 325° C.

9. The process as claimed in claim 8, wherein the light cut (720) is sent at least in part upstream to a distillation column (90) to obtain at least one light cut (910), the final boiling point of which is below or equal to 200° C.

10. The process as claimed in claim 9, wherein said light cut (910), the final boiling point of which is below or equal to 200° C., is sent at least in part to the filtration/washing zone (40) as washing solvent according to step b) of said process.

11. The process as claimed in claim 1, wherein step
b) comprises the following substeps:
b1) filtering the liquid effluent (320) in a washing and filtration device (41) to obtain a filtered carbon black cake and a liquid fraction (425);
b2) washing the filtered carbon black cake obtained at the end of step b1) in the presence of a washing solvent to obtain a filtered and washed carbon black cake (430) and a washing stream (405).

12. The process as claimed in claim 11, wherein the washing stream (405) is sent to an intermediate fractionation unit (42) to obtain a cut (610) which is recycled at least in part upstream of the washing and filtration device (41) as washing solvent.

13. The process as claimed in claim 1, wherein the hydrocarbon cut (730) has a content of C10-C20 hydrocarbon compounds of between 20% and 65% by weight relative to the total weight of the hydrocarbon cut.

14. The process as claimed in claim 1, wherein the hydrocarbon cut (730) has a content of C20-C40 hydrocarbon compounds of between 30% and 80% by weight relative to the total weight of the hydrocarbon cut.

15. The process as claimed in claim 1, wherein the hydrocarbon cut (730) has an initial boiling point of between 50° C. and 325° C. and a final boiling point of between 350° C. and 520° C.
